(19) United States
(12) Patent Application Publication
(10) Pub. No.: US 2011/0271683 A1
(43) Pub. Date: Nov. 10, 2011

(54) TURBOMACHINE INJECTION NOZZLE ASSEMBLY

(75) Inventors: Richard William Johnson, Greer, SC (US); Bryan Wesley Romig, Simpsonville, SC (US)

(73) Assignee: GENERAL ELECTRIC COMPANY, Schenectady, NY (US)

(21) Appl. No.: 12/775,679

(22) Filed: May 7, 2010

(51) Int. Cl. F02C 7/22

(52) U.S. Cl. 60/748

(57) ABSTRACT

A turbomachine includes a compressor, a turbine, a combustor operatively coupled to the compressor and the turbine, and an injection nozzle assembly mounted in the combustor. The injection nozzle assembly includes a swirler member for conditioning a fluid flow passing through the injection nozzle assembly. The swirler member includes a hub portion, a plurality of vanes that extend from the hub portion, and at least one flow conditioning band. The at least one flow conditioning band extends about the hub portion and between the plurality of vanes to provide a localized flow impediment within the injection nozzle assembly.

### BACKGROUND OF THE INVENTION

The subject matter disclosed herein relates to the art of turbomachines and, more particularly to an injection nozzle assembly for a turbomachine.

In general, gas turbomachine engines combust a fuel/air mixture that releases heat energy to form a high temperature gas stream. That is, fuel and air are directed through an injection nozzle into a combustor and ignited to form a high temperature gas stream. The high temperature gas stream is channeled to a turbine via a hot gas path. The turbine converts thermal energy from the high temperature gas stream to mechanical energy that rotates a turbine shaft. The turbine may be used in a variety of applications such as providing power to a pump or an electrical generator.

Currently, there is a need to lower turbomachine emissions. One path to lower emissions lies in creating a more stable flame front within the combustor. In many injection nozzle assemblies, a fluid flow is passed through a swirler. The swirler, as the name implies, imparts a swirl to the fluid flow with one benefit being increased downstream stability. At present, the velocity distribution of the flow downstream of the swirler can be highly non-uniform. This non-uniformity includes a velocity peak around mid-span, and a steep gradient toward an inner radius of the injection nozzle assembly. This velocity profile may create stability issues within the combustor. These stability issues may prevent machine operation in modes that lower emission levels.

### BRIEF DESCRIPTION OF THE INVENTION

According to one aspect of the invention, a turbomachine includes a compressor, a turbine, a combustor operatively coupled to the compressor and the turbine, and an injection nozzle assembly mounted in the combustor. The injection nozzle assembly includes a swirler member for conditioning a fluid flow passing through the injection nozzle assembly. The swirler member includes a hub portion, a plurality of vanes that extend from the hub portion, and at least one flow conditioning band. The at least one flow conditioning band extends about the hub portion and between the plurality of vanes to provide a localized flow impediment within the injection nozzle assembly.

According to another aspect of the invention, a turbomachine injection nozzle assembly includes a swirler member for conditioning a fluid flow passing through the injection nozzle assembly. The swirler member includes a hub portion, a plurality of vanes that extend from the hub portion, and at least one flow conditioning band. The at least one flow conditioning band extends about the hub portion and between the plurality of vanes to provide a localized flow impediment within the injection nozzle assembly.

According to yet another aspect of the invention, a method of conditioning an airflow in a turbomachine injection nozzle assembly includes guiding a fluid into the turbomachine injection nozzle assembly, and directing the fluid through a swirler member arranged in the turbomachine injection nozzle assembly. The swirler member includes a hub portion, and a plurality of vanes radiating from the hub portion. The method further includes passing the fluid across the plurality of vanes, and impeding a portion of the fluid passing between the plurality of vanes.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional side view of a turbomachine including an injection nozzle assembly having a swirler member in accordance with an exemplary embodiment;

FIG. 2 is a cross-sectional view of the injection nozzle assembly of FIG. 1;

FIG. 3 is partial side view of the injection nozzle assembly of FIG. 2, illustrating a flow conditioning band mounted to the swirler member in accordance with an exemplary embodiment;

FIG. 4 is a partial perspective view of the injection nozzle assembly of FIG. 2, illustrating first and second flow conditioning bands mounted to the swirler member in accordance with an exemplary embodiment;

FIG. 5 is a cross-sectional view of a flow conditioning band in accordance with one aspect of an exemplary embodiment;

FIG. 6 is a cross-sectional view of a flow conditioning band in accordance with another aspect of an exemplary embodiment;

FIG. 7 is a cross-sectional view of a flow conditioning band in accordance with still another aspect of an exemplary embodiment; and

FIG. 8 is a graph illustrating a fluid flow velocity distribution downstream of the injection nozzle assembly with a flow conditioning band and an injection nozzle assembly without a flow conditioning band.

The detailed description explains embodiments of the invention, together with advantages and features, by way of example with reference to the drawings.

### DETAILED DESCRIPTION OF THE INVENTION

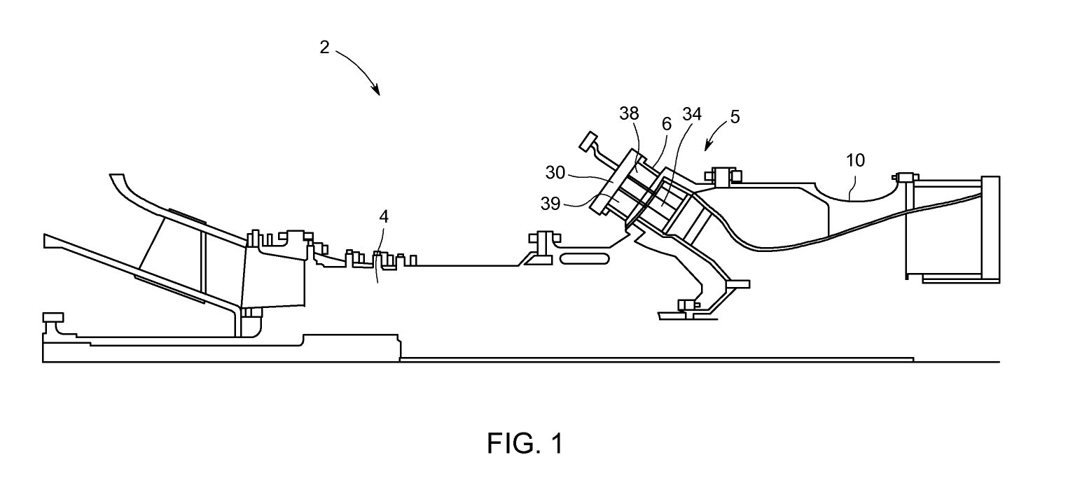

With reference to FIG. 1, a turbomachine, constructed in accordance with an exemplary embodiment, is indicated generally at 2. Turbomachine 2 includes a compressor 4 and a combustor assembly 5 having at least one combustor 6. Turbomachine 2 also includes a turbine section 10. Notably, the disclosed exemplary embodiments described herein may be incorporated into a variety of turbomachines. Turbomachine 2 shown and described herein is just one exemplary arrangement.

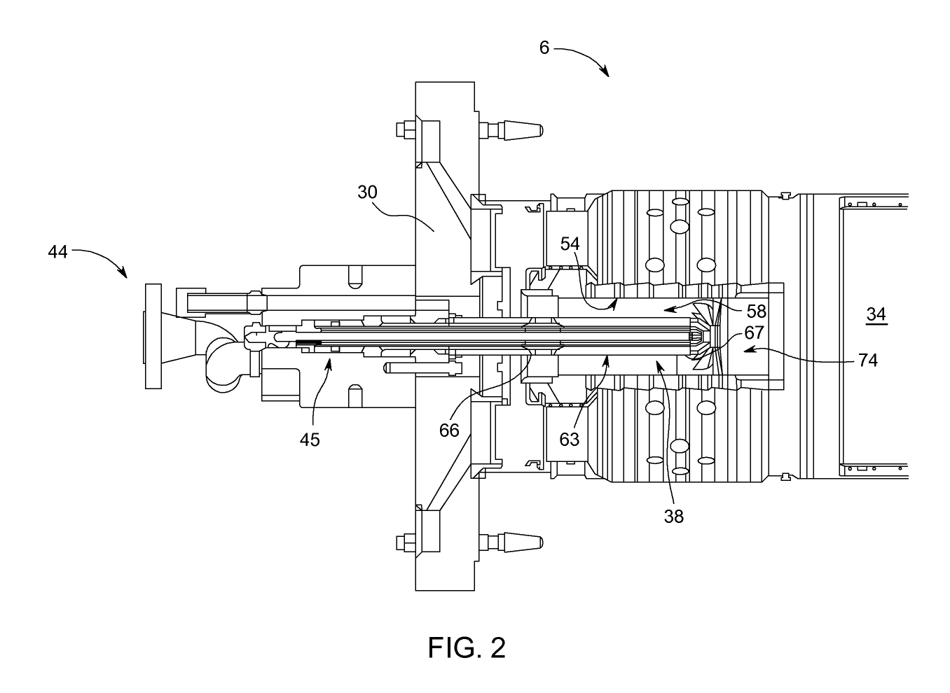

As shown, combustor 6 is coupled in flow communication with compressor 4 and turbine section 10. Combustor 6 includes an end cover 30 positioned at a first end thereof and a combustion chamber 34 positioned at a second end thereof. End cover 30 provides support to a plurality of fuel or injection nozzle assemblies, two of which are indicated at 38 and 39. At this point, reference will be made to FIG. 2 in describing injection nozzle assembly 38 with an understanding the injection nozzle assembly 39 includes similar structure.

Injection nozzle assembly 38 includes a fuel inlet portion 44 having a valve assembly 45. Injection nozzle assembly 38 also includes a centerbody 54 that defines, in part, a primary mixing zone 58. Fuel and air are mixed, enter into primary mixing zone 58 and pass into combustion chamber 34 to be ignited. During certain operational modes, a portion of the fuel is directed through a secondary fuel nozzle 63 before being reintroduced into primary mixing zone 58. Secondary fuel nozzle 63 includes an upstream end 66 that is fluidly linked to fuel inlet 44 and a downstream end 67 that leads toward combustion chamber 34. Downstream end 67 includes a plurality of outlets, one of which is indicated at 69 in FIG. 4, for discharging purge air during and between various operational modes. The discharge of purge air is carried out to substantially limit a flame from entering into secondary fuel nozzle 63.

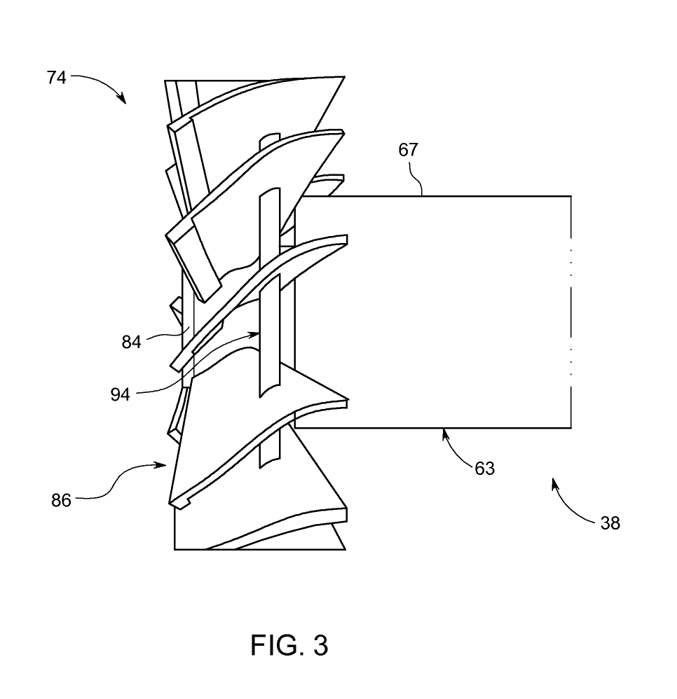

In accordance with an exemplary embodiment illustrated in FIGS. 3 and 4, injection nozzle assembly 38 is also shown to include a swirler member 74 arranged at downstream end 67 of secondary fuel nozzle 63. Swirler member 74 is configured to impart a “swirl” to the fuel/air mixture passing from primary mixing zone 58 to combustion chamber 34. The “swirl” enhances mixing of the fuel and air resulting in a more complete combustion. Swirler member 74 includes a hub portion 84 and a plurality of vanes indicated generally at 86. Vanes 86 extend radially outward from hub member 84 and include a pitch and profile configured to impart a desired “swirl” to the fuel/air mixture passing through primary mixing zone 58. In order to further engineer airflow passing over the plurality of vanes 86, swirler member 74 includes a first flow conditioning band 94 and a second flow conditioning band 95 (FIG. 4). First and second flow conditioning bands 94 and 95 extend radially about hub portion 84 and between the plurality of vanes 86 to create an impediment to a portion of the fuel/air mixture passing through primary mixing zone 58. As will be discussed more fully below, the impediment to the fuel/air flow enhances flame stability within combustor 6.

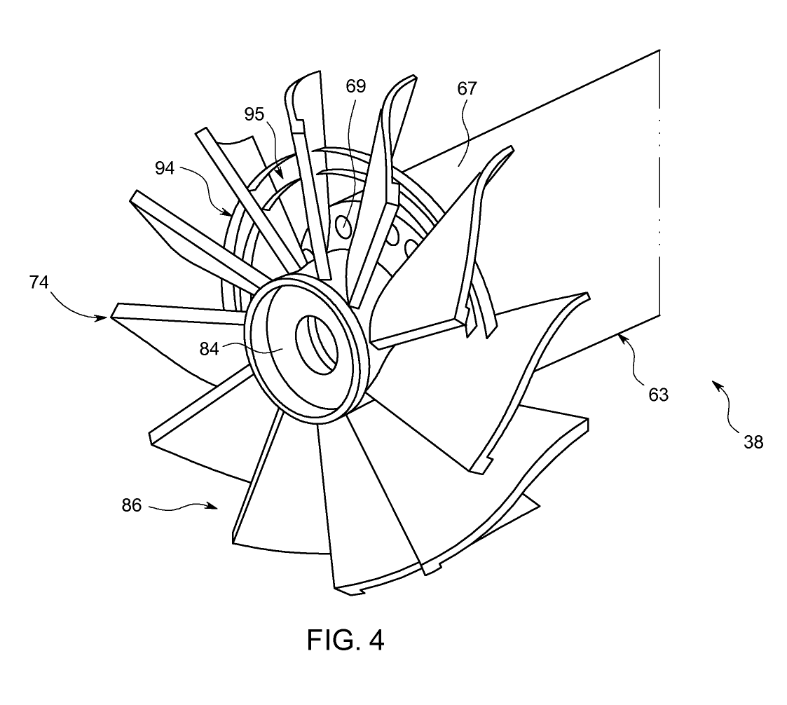

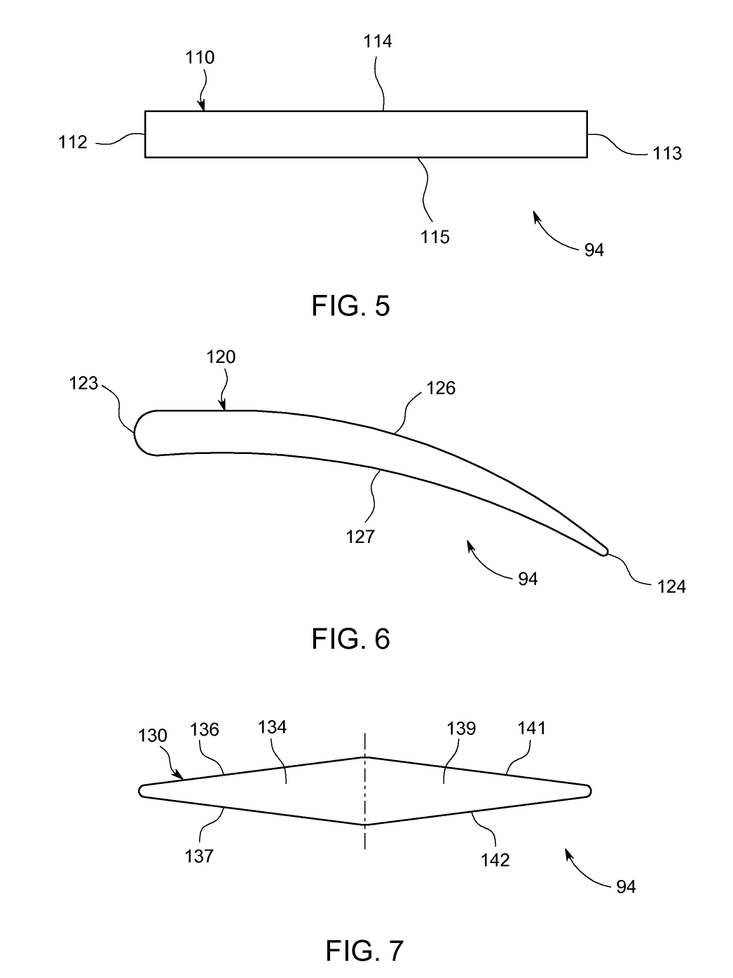

In accordance with one aspect of the exemplary embodiment, each flow conditioning band 94, 95 includes a rectangular profile such as indicated at 110 in FIG. 5. Rectangular profile 110 includes first and second vertical sides 112 and 113 that are joined by horizontal sides 114 and 115. Of course it should be understood that the terms vertical and horizontal are used for descriptive purposes only and should not be considered to be limiting orientations. With this arrangement, side 114 and/or side 115 provides an impediment to the flow of fuel/air passing through primary mixing zone 58. In accordance with another aspect of the exemplary embodiment, each flow conditioning band 94, 95 includes an aerodynamic profile such as shown at 120 in FIG. 6. Aerodynamic profile 120 includes first and second generally rounded surfaces 123 and 124 that are joined by opposing curvilinear surfaces 126 and 127 thereby defining an airfoil. In a manner similar to that described above, curvilinear surfaces 126 and 127 provide an impediment to the flow of fuel/air passing through primary mixing zone 58. In accordance with yet another aspect of the exemplary embodiment, flow conditioning bands 94 and 95 include an aerodynamic profile such as shown at 130 in FIG. 7. Aerodynamic profile 130 includes a first generally triangular portion 134 having first and second angled surfaces 136 and 137, and a second generally triangular portion 139 having first and second angled surfaces 141 and 142. At this point it should be understood that the above described geometries are exemplary. The flow conditioning bands in accordance with exemplary embodiments can take on a variety of forms, shapes, and/or dimensions. It should also be understood that flow conditioning bands 94 and 95 could include similar profiles or each be formed with a different profile. For example, flow conditioning band 94 could include a rectangular profile while flow conditioning band 95 could include an aerodynamic profile.

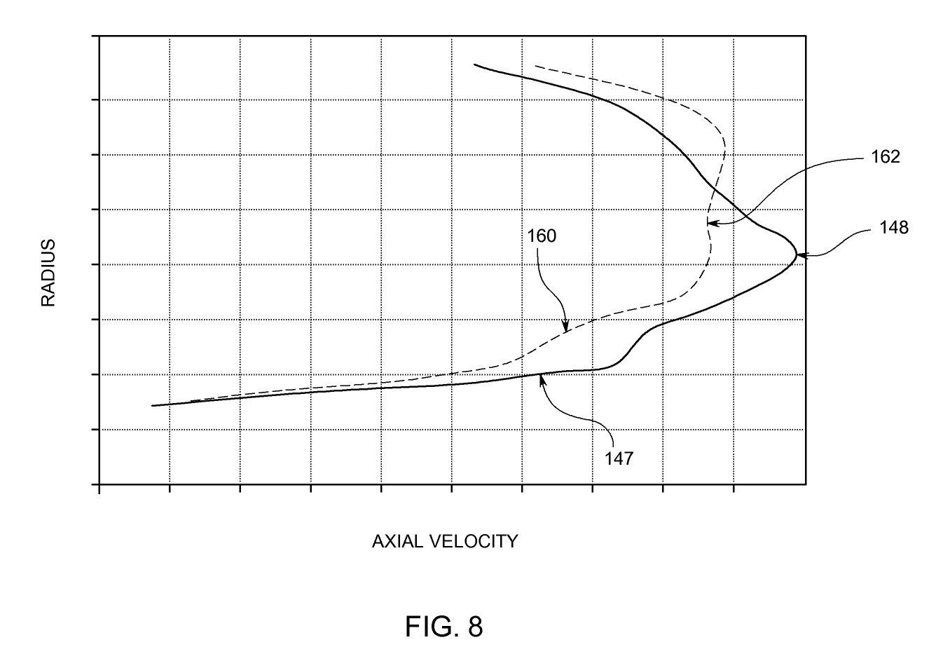

Each of the above profiles establishes a particular impediment to the fuel/air mixture flow passing through primary mixing zone 58 to achieve a more stable flame front. As shown in FIG. 8, in conventional fuel injector systems, the fuel/air mixture flow has a non-uniform velocity profile 147 with a mid-span peak 148 and a steep velocity gradient toward an inner radius of the injection nozzle assembly. In contrast, the flow conditioning bands in accordance with the exemplary embodiments provide an injection nozzle assembly that generates a fuel/air mixture that possesses a velocity profile 160 having a substantially constant velocity portion 162. Substantially constant velocity portion 162 has been shown to create a more stable flame front that allows for increased turndown of the fuel thereby improving the blow out point and lowering NOx emissions.

At this point it should be understood that the exemplary embodiments can be employed in a wide array of gas turbomachine and are not limited to the examples shown. Also, while the injection nozzle assembly is shown and described as including two flow conditioning bands, it should be apparent that number and position of the flow condition bands could vary depending upon the desired velocity profile. Finally, it should be understood that the profiles shown for the flow condition band are exemplary and could include various other geometries.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor;
a turbine section;
a combustor operatively coupled to the compressor and the turbine section; and
an injection nozzle assembly mounted in the combustor, the injection nozzle assembly including a swirler member for conditioning a fluid flow passing through the injection nozzle assembly, the swirler member including a hub portion, a plurality of vanes that extend from the hub portion, and at least one flow conditioning band, the at least one flow conditioning band extending about the hub portion and between the plurality of vanes, the at least one flow conditioning band providing a localized flow impediment within the injection nozzle assembly.

2. The turbomachine according to claim 1, wherein the at least one flow conditioning band includes a rectangular profile.

3. The turbomachine according to claim 1, wherein the at least one flow conditioning band includes an aerodynamic profile.

4. The turbomachine according to claim 3, wherein the aerodynamic profile includes at least one rounded surface.

5. The turbomachine according to claim 3, wherein the aerodynamic profile includes at least one curvilinear surface.

6. The turbomachine according to claim 3, wherein the aerodynamic profile includes at least one angled surface.

7. The turbomachine according to claim 3, wherein the aerodynamic profile includes at least one generally triangular portion.

8. The turbomachine according to claim 7, wherein the at least one generally triangular portion includes a first generally triangular portion and a second generally triangular portion.

9. The turbomachine according to claim 1, wherein the at least one flow conditioning band includes first and second flow conditioning bands arranged concentrically about the hub portion.

10. A turbomachine injection nozzle assembly comprising:
a swirler member for conditioning a fluid flow passing through the injection nozzle assembly, the swirler member including a hub portion, a plurality of vanes that extend from the hub portion, and at least one flow conditioning band, the at least one flow conditioning band extending about the hub portion and between the plurality of vanes, the at least one flow conditioning band providing a localized flow impediment within the injection nozzle assembly.

11. The turbomachine injection nozzle assembly according to claim 10, wherein the at least one flow conditioning band includes a rectangular profile.

12. The turbomachine injection nozzle assembly according to claim 10, wherein the at least one flow conditioning band includes an aerodynamic profile.

13. The turbomachine injection nozzle assembly according to claim 12, wherein the aerodynamic profile includes at least one rounded surface.

14. The turbomachine injection nozzle assembly according to claim 12, wherein the aerodynamic profile includes at least one curvilinear surface.

15. The turbomachine injection nozzle assembly according to claim 12, wherein the aerodynamic profile includes at least one angled surface.

16. The turbomachine injection nozzle assembly according to claim 15 wherein the aerodynamic profile includes at least one generally triangular portion.

17. The turbomachine injection nozzle assembly according to claim 16, wherein the at least one generally triangular portion includes a first generally triangular portion and a second generally triangular portion.

18. The turbomachine injection nozzle assembly according to claim 10, wherein the at least one flow conditioning band includes first and second flow conditioning bands arranged concentrically about the hub portion.

19. The turbomachine according to claim 18, wherein each of the first and second flow conditioning bands includes a rectangular profile.

20. The turbomachine according to claim 18, wherein the first flow conditioning band includes a rectangular profile and the second flow conditioning band includes an aerodynamic profile.
